(19) United States
(12) Patent Application Publication
(10) Pub. No.: US 2025/0355736 A1
(43) Pub. Date: Nov. 20, 2025

(54) MESSAGE INTERACTION

(71) Applicant: Beijing Zitiao Network Technology Co., Ltd., Beijing (CN)

(72) Inventor: Yuyang Pan, Beijing (CN)

(21) Appl. No.: 18/822,772

(22) Filed: Sep. 3, 2024

(30) Foreign Application Priority Data
May 14, 2024 (CN) 202410599428.6

(51) Int. Cl. G06F 9/54

(52) U.S. Cl. CPC G06F 9/546

(57) ABSTRACT

Embodiments of the disclosure relate to a message interaction method, apparatus, device and storage medium. The method provided by the disclosure includes: obtaining a control message generated by a first processing entity associated with a target interaction scenario, the target interaction scenario being associated with a plurality of interaction objects, the control message at least indicating that a response to target message content is provided by a set of target interaction objects in the plurality of interaction objects; in response to the control message indicating the set of target interaction objects, and wherein the set of target interaction objects include a second processing entity, sending an indication message to the second processing entity; and obtaining a response message generated by the second processing entity based on the target message content. In this way, embodiments of the disclosure can support controlling message interaction between interaction objects with a processing entity.

### CROSS-REFERENCE

This application claims priority to Chinese Patent Application No. 202410599428.6 filed on May 14, 2024, and entitled “MESSAGE INTERACTION METHOD, APPARATUS, DEVICE AND STORAGE MEDIUM”.

### FIELD

Example embodiments of the present disclosure generally relate to the field of computers, and in specific, to a message interaction method, apparatus, device, and computer-readable storage medium.

### BACKGROUND

With the development of computer technologies, people may interact with various types of objects, for example, other users, or model-based processing entities. Generally, a user can only interact with a single processing entity to perform a session or the like, and it is difficult to achieve collaborative interaction between multiple processing entities.

### SUMMARY

In a first aspect of the present disclosure, a message interaction method is provided. The method includes: obtaining a control message generated by a first processing entity associated with a target interaction scenario, the target interaction scenario being associated with a plurality of interaction objects, the control message at least indicating to provide, by a set of target interaction objects in the plurality of interaction objects, a response for target message content; in response to the set of target interaction objects comprising a second processing entity, sending an indication message to the second processing entity; and obtaining a response message generated by the second processing entity based on the target message content.

In a second aspect of the present disclosure, an apparatus for message interaction is provided. The apparatus includes: a message obtaining module, configured to obtain a control message generated by a first processing entity associated with a target interaction scenario, the target interaction scenario being associated with a plurality of interaction objects, the control message at least indicating to generate, by a group of target interaction objects in the plurality of interaction objects, a response for target message content; an instruction sending module, configured to send an indication message to the second processing entity in response to the group of target interaction objects including a second processing entity; and a response obtaining module, configured to, in response to the group of target interaction objects comprising including a second processing entity, send an indication message to the second processing entity.

In a third aspect of the present disclosure, an electronic device is provided. The device includes at least one processing unit; and at least one memory coupled to the at least one processing unit and storing instructions to be executed by the at least one processing unit, the instructions, when executed by the at least one processing unit, causing the electronic device to perform the method of the first aspect.

In a fourth aspect of the present disclosure, a computer-readable storage medium is provided. The computer-readable storage medium has a computer program stored thereon, and the computer program, when executed by a processor, performs operations that implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment.

FIGS. 2A-2B illustrate an example interface.

FIG. 3 illustrates a flowchart of an example process of controlling message interaction.

FIG. 4 illustrates a flowchart of an example message interaction process.

FIG. 5 illustrates a schematic structural block diagram of an example apparatus for message interaction.

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the headline of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below. The terms “first,” “second,” and the like may refer to different or identical object. Other explicit and implicit definitions may also be included below.

Embodiments of the present disclosure may relate to data of a user, including acquisition and/or use of data, and the like. These aspects all follow the corresponding laws and regulations and related regulations. In the embodiments of the present disclosure, all data is collected, obtained, processed, fabricated, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, if personal information processing is involved, processing may be performed on the premise of having a legal basis (for example, obtaining consent of a personal information subject, or necessary for performing a fulfillment contract), and processing may be performed only within a specified or agreed range. The user rejects personal information other than necessary information required by the basic function, and does not affect the basic function of the user.

Conventionally, user support models, plug-ins, etc. are used by configuration applications to quickly create applications, such as bots. Generally, such an application only supports a user interacting with a single processing entity to perform a session or the like, and it is difficult to implement collaborative interaction between multiple processing entities.

The embodiments of the invention provide a message interaction scheme. According to the scheme, a control message, generated by a first processing entity associated with a target interaction scenario, is obtained. The target interaction scenario is associated with a plurality of interaction objects, and the control message at least indicating the provision, by a set of target interaction objects in the plurality of interaction objects, of a response for target message content. In response to the set of target interaction objects comprising a second processing entity, an indication message is sent to the second processing entity; and a response message generated by the second processing entity based on the target message content is obtained.

In this way, embodiments of the present disclosure can support controlling message interaction between an interaction object and a processing entity.

Various example implementations of this scheme are described in detail below in conjunction with the accompanying drawings.

### Example Environment

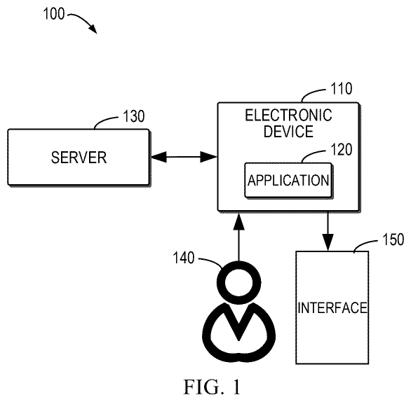

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to, development applications or other suitable applications that support application development. The user 140 may interact with the application 120 via the electronic device 110 and/or its attachment device.

In the environment 100 of FIG. 1, if the application 120 is in an active state, the electronic device 110 may present an interface 150 for supporting interaction through the application 120.

In some embodiments, the electronic device 110 communicates with the server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenario in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Creation of Target Applications

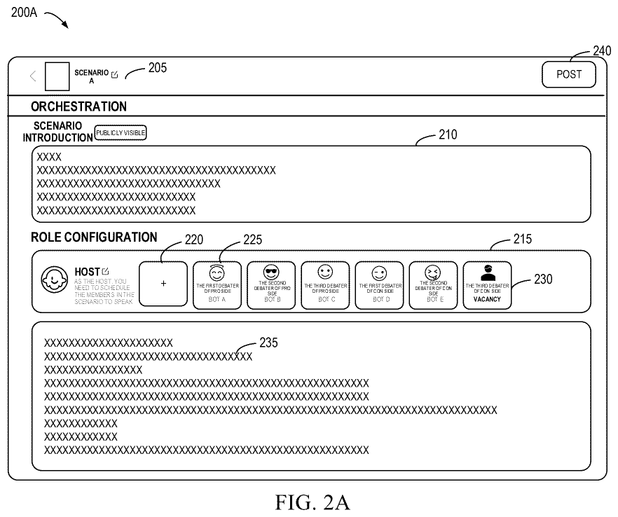

FIG. 2A illustrates an example interface 200A, in accordance with some embodiments of the present disclosure. The interface 200A may be provided, for example, by the electronic device 110. An example process of creating an application according to an embodiment of the present disclosure will be described below in conjunction with the interface 200A.

As shown in FIG. 2A, the electronic device 110 may present the configuration interface 200A shown in FIG. 2A based on the creation request of the user. The configuration interface 200A may be configured to receive configuration information to create an application associated with the target interaction scenario.

As an example, the electronic device 110 may present the configuration interface 200A based on an application identification or a scenario identification (e.g., scenario A) 205 of the user input. As shown in FIG. 2A, the configuration interface 200A may include an input control 210 configured to obtain scenario description information about the target interaction scenario.

As an example, such scenario description information may include a piece of description text for describing an interaction scenario to be created. Such scenario description information may be public information visible to an interaction object joining the interaction scenario. When the interaction object includes a preset processing entity (for example, a smart agent, or another application, for example, bot), such scenario description information may be provided to a corresponding preset processing entity for controlling interaction of the preset processing entity in the interaction scenario.

Taking the debate scenario shown in FIG. 2A as an example, such scenario description information may include, for example, the topic of the debate, the arguments of the pro side, the arguments of the con side, and so on.

In some embodiments, as shown in FIG. 2A, the configuration interface 200A may further include a role configuration control 215, configured to obtain a group of preset roles associated with the target interaction scenario.

As shown in FIG. 2A, the electronic device 110 may support the user adding a plurality of preset roles in the interaction scenario. By taking the debate scenario as an example, the user may, for example, add roles such as the first debater of pro side to the third debater of pro side and the first debater of con side to the third debater of con side.

In the interaction process, a set of interaction object joining the interaction scenario will be assigned to a corresponding preset role. As will be described below, such interaction objects may include user for example, user object, or may also include configured processing entities, e.g., agents or bots, etc.

As shown in FIG. 2A, the electronic device 110 may provide an add entry 220 for initiating a role adding request. Upon receiving the selection to the add entry 220, electronic device 110 may obtain role setting information about the role to be added for creating the corresponding role. For example, the electronic device 110 may obtain a role identification (for example, a name) of the role.

Additionally, the electronic device 110 may also determine visibility information for the role. The visibility information may be used to describe whether the role information corresponding to the role is visible to another role. As an example, the role information of each interaction object is visible to other objects. Thus, the user may, for example, set “first debater of pro side” to be visible to all roles.

As another example, in some interaction scenarios, some interaction objects need to hide their role information in a specific stage. Accordingly, the user may set the visibility information of the role to be visible, for example, to only the host (the processing entity for scheduling as will be described below).

Further, the electronic device 110 may further support the user to associate the role to a preset processing entity or to a vacancy interaction object. As an example, the electronic device 110 may present a group of candidate processing entities that the user has permission to add (for example, a group of Bots created by the user or to which the user has permission to access), and may further select a specific processing entity to associate with the role.

As an example, the electronic device 110 may further support editing an identification (for example, a nickname) of the processing entity in the target interaction scenario; and may support editing the description text about the processing entity. In some embodiments, such identification and description text may be provided to other processing entities in the interaction scenario. For example, such identification and description text may be provided to a processing entity associated with other roles, or a specific processing entity for scheduling, etc.

Continuing to refer to FIG. 2A, the electronic device 110 may display, in the role configuration control 215, a role indication element corresponding to the added one or more preset roles, for example, a role indication element 225 and a role indication element 230.

As shown in FIG. 2A, a role (e.g., a first debater of pro side) corresponding to the role indication element 225 may be associated with a specified processing entity. Correspondingly, the role indication element 225 may display the image identification (for example, the image identification of Bot A) corresponding to the processing entity, the name of the role, and the nickname of the associated processing entity in the interaction scenario.

As another example, the role corresponding to the role indication element 230 (e.g., the third debater of con side) is associated with the vacancy interaction object. In some scenarios, the association to the vacancy interaction object may indicate that the role is not provided with a corresponding preset processing entity. That is, other users may specify to participate in and associate with the role in the interaction process with the target application, or other processing entities may be selected and associated with the role.

Accordingly, as shown in FIG. 2A, the role indication element 230 may display corresponding object information (e.g., “vacancy”) to indicate that it is associated with a vacancy interaction object. In addition, the role indication element 230 may display preset image content.

Further, as shown in FIG. 2A, the configuration interface 200A may further include an input control 235 configured to obtain the interaction control information. In some embodiments, the interaction control information may include a piece of text used to describe an interaction rule and/or control logic of the interaction scenario.

In some embodiments, such interaction control information may be provided for creating a target processing entity (i.e., the host role mentioned above) in the interaction scenario. In some embodiments, the target processing entity may be configured to manage an interaction process of the plurality of interaction objects in the interaction scenario.

For example, the interaction control information may describe, for example, a process of an entire debate process, a speech sequence of each role, content that needs to be output by a host role, and the like.

In some embodiments, such a target processing entity may be implemented based on a machine learning model. For example, the electronic device 110 may provide the interaction control information acquired by the input control 235 to the target model to instruct the target model to manage the interaction process of the plurality of interaction objects in the interaction scenario according to the content described by the interaction control information.

Further, the electronic device 110 may, for example, receive a selection of the issuing entry 250 by the user to create and publish the target application based on the received configuration information.

### Example Interaction of Target Applications

In some embodiments, the electronic device 110 may receive a startup request or a debugging request of the user for the target application and may correspondingly present a session interface of the target application.

In some embodiments, in a case that the configuration information received via FIG. 2A indicates that the role (for example, third debater of con side) is associated with the vacancy interaction object, the electronic device 110 may configure, via the setting window, the interaction object corresponding to the role (for example, the third debater of con side).

In some embodiments, the electronic device 110 may, for example, configure the current user object as an interaction object corresponding to the role based on a configuration operation of the user. In this case, the user may participate in the target interaction scenario through a session, for example.

Alternatively, the electronic device 110 may further configure the specified processing entity as the target interaction object corresponding to the role based on a configuration of the user. For example, the electronic device 110 may present a group of candidate processing entities with a preset permission for the current user, for example, bots. Further, the electronic device 110 may select a specific processing entity to associate the specific processing entity to the target role.

In some embodiments, if the group of preset roles includes a plurality of roles associated with a vacancy interaction object, the electronic device 110 may, for example, support the user respectively configuring the interaction object corresponding to each role. In some embodiments, a single user object may, for example, only support associating to a unique role, or a single processing entity only supports associating to a unique role.

In still other embodiments, if the group of preset roles are all associated with a preset processing entity, the electronic device 110 may, for example, directly present the session interface 200B shown in FIG. 2B.

In some embodiments, the electronic device 110 may display, in the session interface 200B, an interaction message from a plurality of interaction objects joining the target interaction scenario. As an example, after the user enters the target application, the first processing entity (for example, corresponding to the host role) may provide an interaction message, or an opening message.

In some embodiments, the first processing entity may control the plurality of interaction objects joining the interaction scenario to provide the corresponding interaction message in a specified order based on the interaction control information described above. As an example, the first processing entity may, for example, sequentially control the interaction object corresponding to different debater roles to sequentially provide the interaction message according to a debate process.

As shown in FIG. 2B, the first processing entity may also provide, for example, a first interaction message 245-1 for instructing the corresponding interaction objects to respond. For example, the first interaction message 245-1 may indicate that the specific roles (e.g., third debater of con side and third debater of pro side) respond sequentially.

As shown, the interaction information 250-1 for the third interaction message 245-1 may indicate a first set of interaction objects that receive the first interaction message 245-1. Alternatively, or additionally, the interaction information 250-1 may also indicate a second set of interaction objects to respond to the first interaction message 245-1, and/or a response order about the second set of interaction objects for the first interaction message 245-1.

Using FIG. 2B as an example, the interaction information 250-1 may indicate that the interaction object (user A) and the interaction object (BOT C) respond to the first interaction message 245-1 in sequence.

Further, as shown in FIG. 2B, after determining that the target interaction object for responding to the first interaction message 245-1 includes a user object, the electronic device 110 may enable an input control associated with the user object to obtain an input message of the user object. Conversely, if the target interaction object does not include the user object, or the interaction object to respond is not the user object, the electronic device 10 may, for example, disable the input control 255 as shown in FIG. 2B.

Further, as shown in FIG. 2B, the electronic device 110 may further display a second interaction message 245-2 and corresponding interaction information 250-2 created based on the input message, to indicate that the receivers of the second interaction message 245-2 includes the host and the BOT C.

Accordingly, after the user completes the input of the second interaction message 245-2, the electronic device 110 may acquire the third interaction message 245-3 generated by the designated processing entity (e.g., BOT C) based on the first interaction message 245-1 and the second interaction message 245-2. By way of example, the third interaction message 245-3 may include, for example, contrastive content about a perspective in the second interaction message 245-2.

Similarly, the electronic device 110 may display the interaction information 250-3 of the third interaction message 245-3 to indicate that the receivers of the third interaction message 245-3 includes the host and the user A.

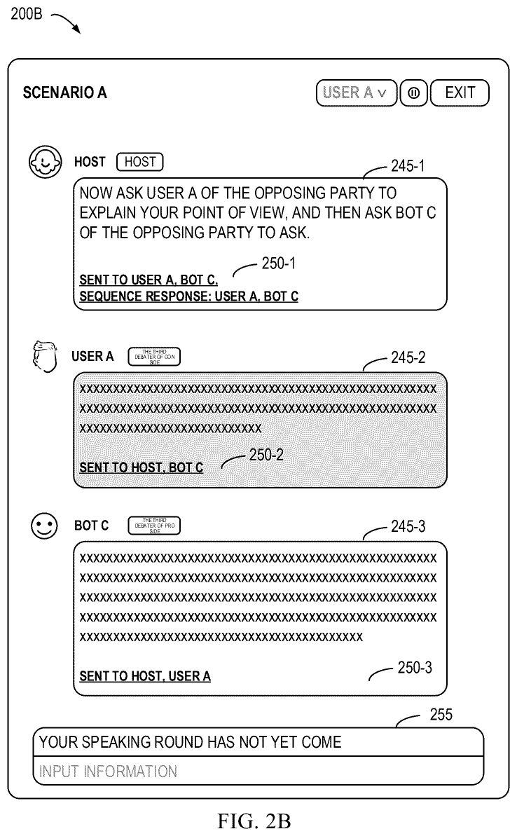

The generation and control process of the interaction message in the target interaction scenario will be described in detail below with reference to FIG. 3.

### Control Process for Message Interactions

In some embodiments, as introduced above, the first control entity created based on the configuration information may manage interaction of the plurality of interaction objects in the target interaction scenario based on the interaction control information. FIG. 3 illustrates a flowchart of an example process 300 of interaction control in accordance with some embodiments of the present disclosure. As an example, process 300 may be performed, for example, by an interaction control system.

Specifically, as shown in FIG. 3, at block 302, the interaction control system may start a scenario. In block 304, the interaction control system may integrate the scenario information, and such scenario information may include, for example, an operation rule indicated by the interaction control information, scenario description information about the target scenario, and object description information of each interaction object joining the interaction scenario.

As an example, such object description information may include a name of each interaction object joining the interaction scenario, a corresponding role, description text and other information.

Further, at block 306, such scenario information may be provided to the first processing entity 310 to perform scheduling. Further, parts of such scenario information may also be provided to other processing entities joining the target interaction scenario, e.g., bot 332.

As an example, the electronic device 110 may further create a system prompt of the bot 332 based on the scenario description information. Additionally, object description information of each interaction object joining the interaction scenario may also be sent to the bot 332.

Further, after starting the interaction scenario, in block 308, the interaction control system may send a start message to the first processing entity 310, to trigger the first processing entity 310 to generate a corresponding control message according to the interaction control information described above. For example, at block 312, the interaction control system may issue the session task based on the control message generated by the first processing entity 310.

In some embodiments, the control message may indicate that a response to the target message content is generated by a set of target interaction objects of the plurality of interaction objects in the interaction scenario. Such a set of target interaction objects may also be referred to as repliers.

In some embodiments, the control message may further include, for example, target message content to be processed. The target message content may be, for example, text content generated by the first processing entity 310 based on the interaction control information, to trigger a corresponding interaction object to perform a task corresponding to the current interaction stage.

In some embodiments, the electronic device 110 may further display, in the session interface, an interaction message corresponding to the target message content, for example, the first interaction message 245-1 described above.

Additionally, the control message may further include at least one interaction object that receives the target message content and is also a receiver. As an example, the electronic device 110 may display the receivers of the corresponding interaction message by using the interaction information in the session interface.

Additionally, the control message may further include a response mode of the target interaction object responding to the target message content, and the response mode includes a sequential response mode or a parallel response mode. Taking FIG. 2B as an example, since the BOT C needs to refute the input content of the user, the two may correspond to the sequential response mode. In some scenarios, for example, in a free debate stage, the first processing entity may, for example, configure the plurality of interaction objects to respond to the target message content based on the parallel response mode.

Additionally, the control message may also indicate a visible range of response messages provided by the interaction object. Taking FIG. 2B as an example, the receivers indicated in the interaction information 250-2 and the interaction information 250-3 may be determined based on the visible range.

Additionally, the control message may also indicate whether to end the target interaction scenario, e.g., to terminate the session interaction of the plurality of interaction objects.

Continuing to refer to FIG. 3, at block 314, the interaction control system may insert the initial content (i.e., the target message content to be processed) into the context 330 of the receivers indicated by the control message.

Further, in block 316, the interaction control system may determine a message reply mode indicated by the control message, and may execute a corresponding trigger policy. Taking the sequential response mode as an example, the interaction control system may sequentially trigger, at block 318, one or more target interaction object that need to process the target message content.

In some embodiments, when the target object is the processing entity, the interaction control system may obtain a response message generated by the processing entity (for example, BOT 332) based on the target message content and the context information, the scenario description information, and the like. Specifically, the interaction control system may send an indication message to the BOT 332 to indicate the BOT 332 to generate a response message about the target message content.

In some embodiments, in a case that the target object is a user object, the interaction control system may enable an input control associated with the user object and obtain an input message as a response. As shown in FIG. 2B, such a response message may include, for example, a second interaction message 245-2.

Further, at block 320, the interaction control system may update context information of at least one associated processing entity (e.g., the receivers of the response message) associated with the response message based on the received response message. Taking FIG. 2B as an example, a receiver of the second interaction message 245-2 may include a processing entity BOT C. Accordingly, the interaction control system may update the context information of the processing entity BOT C based on the second interaction message 245-2.

As shown in FIG. 3, the interaction control system may determine whether all interactive objects have been triggered to execute a response at block 322, and if not, return to block 318 to continue the triggering process. Taking FIG. 2B as an example, the interaction control system may update the context information of the BOT C after receiving the second interaction message 245-2 of the user object, and trigger the BOT C to process the target message content corresponding to the first interaction message 245-1 based on the updated context information. Correspondingly, the interaction control system may obtain the response message generated by the BOT C and may correspondingly display the corresponding third interaction message 245-3.

Continuing to refer to FIG. 3, unlike the sequential response mode, if the control message indicates a parallel response mode, the interaction control system may substantially simultaneously trigger the set of target interaction objects at block 324 in parallel to obtain the response content generated by the set of target interaction objects.

Similarly, at block 326 the interaction control system may update context information of the associated one or more processing entities based on the received response received receiver information.

Continuing to refer to FIG. 3, at block 328, the interaction control system may determine whether an end interaction scenario needs to be ended based on the control message. If so, the interaction control system may end the interaction scenario at block 334.

Conversely, if it is determined to continue the interaction scenario, the interaction control system may trigger the first processing entity 310 to generate a new control message. In some embodiments, such a new control message may be generated based on the context information described above and the updated context information of the first processing entity.

In this way, the embodiments of the present disclosure can automatically schedule interaction of the multi-interaction object in the target interaction scenario by using a processing entity (for example, a smart agent or a bot), thereby improving the interaction efficiency.

### Example Processes

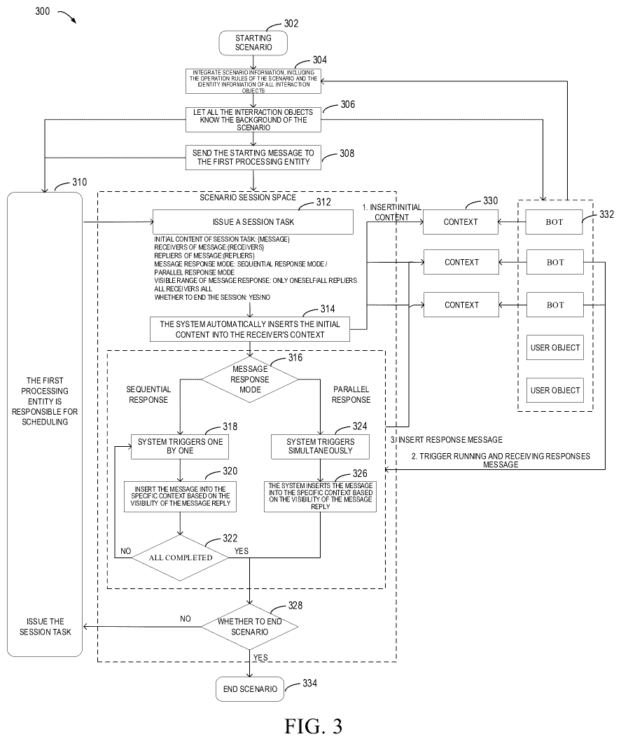

FIG. 4 illustrates a flowchart of an example process 400 of message interaction in accordance with some embodiments of the present disclosure. Process 400 may be implemented at electronic device 110 and/or server 130. The process 400 is described below with reference to FIG. 1.

As shown, in block 410, a control message generated by a first processing entity associated with a target interaction scenario is obtained, the target interaction scenario is associated with a plurality of interaction objects, and the control message at least indicates that a response to the target message content is generated by a set of target interaction objects in the plurality of interaction objects.

At block 420, in response to the set of target interaction objects including the second processing entity, an indication message is sent to the second processing entity.

At block 430, a response message generated by the second processing entity based on the target message content is obtained.

In some embodiments, the control message further indicates at least one of: at least one interaction object for receiving target message content; a response mode in which the set of target interaction objects respond to the target message content, wherein the response mode comprising a sequential response mode or a parallel response mode; a visible range of a response message provided by the set of target interaction objects.

In some embodiments, obtaining the control message generated by the first processing entity associated with the target interaction scenario comprises: sending scenario information to the first processing entity, wherein the scenario information comprises scenario description information about the target interaction scenario, interaction control information associated with the target interaction scenario, and object description information about the plurality of interaction objects; and obtaining the control message generated by the first processing entity based on the scenario information.

In some embodiments, process 400 further includes providing the scenario description information and/or the object description information to at least one interaction object in the plurality of interaction object associated with a processing entity.

In some embodiments, the process 400 further includes: displaying a first interaction message from the first processing entity in a session interface associated with the target interaction scenario based on the control message; and/or displaying a second interaction message from the second processing entity in the session interface based on the response message.

In some embodiments, the process 400 further includes: determining, based on the control message, first interaction information corresponding to the first interaction message and/or second interaction information corresponding to the second interaction message; and displaying the first interaction information and/or the second interaction information in the session interface.

In some embodiments, the first interaction information indicates at least one of: an interaction object to which the first interaction message is sent; the set of target interaction objects to respond to the first interaction message; a response order in which the set of target interaction objects respond to the first interaction message.

In some embodiments, the control message is the first control message, and the process 400 further includes: in response to the first control message indicating to end the target interaction scenario, stopping an interaction process associated with the target interaction scenario; or in response to the first control message indicating to continue the target interaction scenario, triggering the first processing entity to generate a second control message.

In some embodiments, the process 400 further includes: updating context information of at least one associated processing entity associated with the response message based on the response message, the at least one associated processing entity corresponding to a recipient receiving the response message.

In some embodiments, the process 400 further includes: in response to the set of target interaction objects comprising a user object, enabling an input control associated with the user object to obtain an input message of the user object.

### Example Apparatus and Device

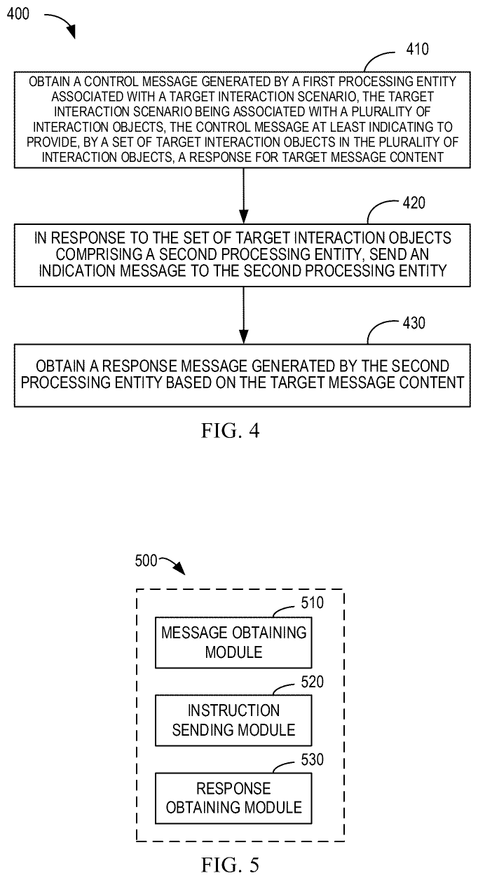

Embodiments of the present disclosure also provide a corresponding apparatus for implementing the above method or process. FIG. 5 shows a schematic structural block diagram of an example apparatus 500 for message interaction according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes a message obtaining module 510, configured to obtain a control message generated by a first processing entity associated with a target interaction scenario, the target interaction scenario being associated with a plurality of interaction objects, the control message at least indicating that a response to target message content is provided by a set of target interaction objects in the plurality of interaction objects; an indication sending module 520, configured to, in response to the control message indicating the set of target interaction objects, and wherein the set of target interaction objects comprise a second processing entity, send an indication message to the second processing entity; and a response obtaining module 530, configured to obtain a response message generated by the second processing entity based on the target message content.

In some embodiments, the control message further indicates at least one of: at least one interaction object for receiving target message content; a response mode in which the set of target interaction objects respond to the target message content, wherein the response mode comprises a sequential response mode or a parallel response mode; or a visible range of a response message provided by the set of target interaction objects.

In some embodiments, the message obtaining module 510 is further configured to: send scenario information to the first processing entity, wherein the scenario information comprises scenario description information about the target interaction scenario, interaction control information associated with the target interaction scenario, and object description information about the plurality of interaction objects; and obtain the control message generated by the first processing entity based on the scenario information.

In some embodiments, the apparatus 500 further includes a providing module configured to provide the scenario description information and/or the object description information to at least one interaction object in the plurality of interaction object associated with a processing entity.

In some embodiments, the apparatus 500 further includes a display module configured to: display a first interaction message from the first processing entity in a session interface associated with the target interaction scenario based on the control message; and/or display a second interaction message from the second processing entity in the session interface based on the response message.

In some embodiments, the display module is further configured to: determine, based on the control message, first interaction information corresponding to the first interaction message and/or second interaction information corresponding to the second interaction message; and display the first interaction information and/or the second interaction information in the session interface.

In some embodiments, the first interaction information indicates at least one of: an interaction object to which the first interaction message is sent; the set of target interaction objects to respond to the first interaction message; a response order in which the set of target interaction objects respond to the first interaction message.

In some embodiments, the control message is the first control message, and the apparatus 500 further includes a control module configured to: in response to the first control message indicating to end the target interaction scenario, stop an interaction process associated with the target interaction scenario; or in response to the first control message indicating to continue the target interaction scenario, trigger the first processing entity to generate a second control message.

In some embodiments, the apparatus 500 further includes an updating module configured to update context information of at least one associated processing entity associated with the response message based on the response message, the at least one associated processing entity corresponding to a recipient receiving the response message.

In some embodiments, the apparatus 500 further includes an input module configured to, in response to the set of target interaction objects comprising a user object, enable an input control associated with the user object to obtain an input message of the user object.

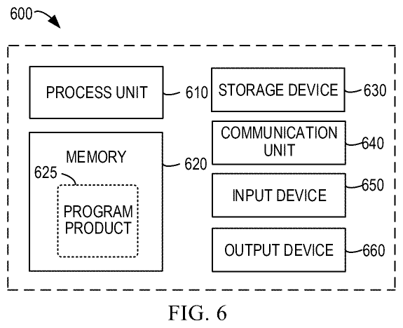

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be configured to implement the electronic device 110 and/or the server 130 of FIG. 1.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor system, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network Node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a specific manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A message interaction method, comprising:
obtaining a control message generated by a first processing entity associated with a target interaction scenario, the target interaction scenario being associated with a plurality of interaction objects, the control message at least indicating that a response to target message content is provided by a set of target interaction objects in the plurality of interaction objects;
in response to the control message indicating the set of target interaction objects, and wherein the set of target interaction objects comprise a second processing entity, sending an indication message to the second processing entity; and
obtaining a response message generated by the second processing entity based on the target message content.

2. The method of claim 1, wherein the control message further indicates at least one of:
at least one interaction object for receiving target message content;
a response mode in which the set of target interaction objects respond to the target message content, wherein the response mode comprises a sequential response mode or a parallel response mode; or
a visible range of a response message provided by the set of target interaction objects.

3. The method of claim 1, wherein obtaining the control message generated by the first processing entity associated with the target interaction scenario comprises:
sending scenario information to the first processing entity, wherein the scenario information comprises scenario description information about the target interaction scenario, interaction control information associated with the target interaction scenario, and object description information about the plurality of interaction objects; and
obtaining the control message generated by the first processing entity based on the scenario information.

4. The method of claim 3, further comprising:
providing the scenario description information and/or the object description information to at least one interaction object in the plurality of interaction object associated with a processing entity.

5. The method of claim 1, further comprising:
displaying a first interaction message from the first processing entity in a session interface associated with the target interaction scenario based on the control message; and/or
displaying a second interaction message from the second processing entity in the session interface based on the response message.

6. The method of claim 5, further comprising:
determining, based on the control message, first interaction information corresponding to the first interaction message and/or second interaction information corresponding to the second interaction message; and
displaying the first interaction information and/or the second interaction information in the session interface.

7. The method according to claim 6, wherein the first interaction information indicates at least one of:
an interaction object to which the first interaction message is sent;
the set of target interaction objects to respond to the first interaction message; or
a response order in which the set of target interaction objects respond to the first interaction message.

8. The method according to claim 1, wherein the control message is a first control message, and the method further comprises:
in response to the first control message indicating to end the target interaction scenario, stopping an interaction process associated with the target interaction scenario; or
in response to the first control message indicating to continue the target interaction scenario, triggering the first processing entity to generate a second control message.

9. The method of claim 1, further comprising:
updating context information of at least one associated processing entity associated with the response message based on the response message, the at least one associated processing entity corresponding to a recipient receiving the response message.

10. The method of claim 1, further comprising:
in response to the set of target interaction objects comprising a user object, enabling an input control associated with the user object to obtain an input message of the user object.

11. An electronic device, comprising:
at least one processing unit; and
at least one memory coupled to the at least one processing unit and storing instructions to be executed by the at least one processing unit, the instructions, when executed by the at least one processing unit, causing the electronic device to perform operations comprising:
obtaining a control message generated by a first processing entity associated with a target interaction scenario, the target interaction scenario being associated with a plurality of interaction objects, the control message at least indicating that a response to target message content is provided by a set of target interaction objects in the plurality of interaction objects;
in response to the control message indicating the set of target interaction objects, and wherein the set of target interaction objects comprise a second processing entity, sending an indication message to the second processing entity; and
obtaining a response message generated by the second processing entity based on the target message content.

12. The electronic device of claim 11, wherein the control message further indicates at least one of:
at least one interaction object for receiving target message content;
a response mode in which the set of target interaction objects respond to the target message content, wherein the response mode comprising a sequential response mode or a parallel response mode; or
a visible range of a response message provided by the set of target interaction objects.

13. The electronic device of claim 11, wherein obtaining the control message generated by the first processing entity associated with the target interaction scenario comprises:
sending scenario information to the first processing entity, wherein the scenario information comprises scenario description information about the target interaction scenario, interaction control information associated with the target interaction scenario, and object description information about the plurality of interaction objects; and
obtaining the control message generated by the first processing entity based on the scenario information.

14. The electronic device of claim 13, further comprising:
providing the scenario description information and/or the object description information to at least one interaction object in the plurality of interaction object associated with a processing entity.

15. The electronic device of claim 11, further comprising:
displaying a first interaction message from the first processing entity in a session interface associated with the target interaction scenario based on the control message; and/or
displaying a second interaction message from the second processing entity in the session interface based on the response message.

16. The electronic device of claim 15, further comprising:
determining, based on the control message, first interaction information corresponding to the first interaction message and/or second interaction information corresponding to the second interaction message; and
displaying the first interaction information and/or the second interaction information in the session interface.

17. The electronic device according to claim 16, wherein the first interaction information indicates at least one of:
an interaction object to which the first interaction message is sent;
the set of target interaction objects to respond to the first interaction message; or
a response order in which the set of target interaction objects respond to the first interaction message.

18. The electronic device according to claim 11, wherein the control message is a first control message, and the operations further comprising:
in response to the first control message indicating to end the target interaction scenario, stopping an interaction process associated with the target interaction scenario; or
in response to the first control message indicating to continue the target interaction scenario, triggering the first processing entity to generate a second control message.

19. The electronic device of claim 11, further comprising:
updating context information of at least one associated processing entity associated with the response message based on the response message, the at least one associated processing entity corresponding to a recipient receiving the response message.

20. A non-transitory computer readable storage medium having a computer program stored thereon, the computer program, when executed by a processor, implementing acts comprising:
obtaining a control message generated by a first processing entity associated with a target interaction scenario, the target interaction scenario being associated with a plurality of interaction objects, the control message at least indicating that a response to target message content is provided by a set of target interaction objects in the plurality of interaction objects;
in response to the control message indicating the set of target interaction objects, and wherein the set of target interaction objects comprise a second processing entity, sending an indication message to the second processing entity; and
obtaining a response message generated by the second processing entity based on the target message content.
